(19) United States
(12) Patent Application Publication
(10) Pub. No.: US 2004/0238501 A1
(43) Pub. Date: Dec. 2, 2004

(54) Electrode material and method for manufacture thereof

(76) Inventors: Masataka Kawazoe, Sendai-shi (JP); Hideyuki Hasegawa, Kurokawa-gun (JP); Katsuyuki Taketani, Namerikawa-shi (JP); Hiroyuki Sasaki, Sendai-shi (JP)

Correspondence Address: Michael S. Leonard, Bell, Boyd & Lloyd LLC, P.O. Box 1135, Chicago, IL, 60690-1135, US

(21) Appl. No.: 10/825,778

(22) Filed: Apr. 16, 2004

(30) Foreign Application Priority Data
May 27, 2003 (JP) 2003-149420

(51) Int. Cl. B23K 11/30

(52) U.S. Cl. 219/119

(57) ABSTRACT

An copper alloy material having a structure in which fine particles with a mean particle size of 50 nm or less have precipitated in a structure composed of fibrous crystal grains with a minor axis length of 10 μm or less which are composed of subgrains with a mean grain size of 3 μm or less is obtained by extruding an alloy material represented by a general formula Cu_{bal.}Xₐ (wherein X is at least one element selected from the group consisting of Cr, Zr, Fe, P, and Ag; a is 1.5% by weight or less, and the balance is Cu comprising unavoidable impurities) at an extrusion ratio of 4 or higher and at a temperature of 300 to 600° C. The copper alloy material is preferably heat treated at a temperature of 350 to 700° C before and after the extrusion. The thus obtained alloy material is useful as an electrode material for welding because of improved mechanical properties, heat resistance, and high-temperature yield stress and exhibits a superior continuous welding ability (electrode life) as an electrode material.

### BACKGROUND OF THE INVENTION

1. Field of the Invention

The present invention relates to an electrode material used in welding materials composed of aluminum, magnesium, iron, alloys thereof, and also materials plated with those metals, and to a method for the manufacture of such an electrode material.

2. Description of the Prior Art

Electrode materials composed of chromium-copper (Cu—Cr alloy) and alumina-dispersed copper (Al₂O₃-dispersed copper) have been used as electrode materials of this type.

For example, Patent Document 1 describes an electrode material for welding composed of a Cr—Cu alloy, the drawback thereof being that the crystal grains in the alloy are coarsened because of the manufacture at a high temperature of about 1000° C., and wear resistance and heat resistance are decreased. However, adding boron at 0.01 to 0.2 wt. % to the Cr—Cu alloy refines the crystal grains of the alloy and improves heat resistance and high-temperature hardness.

Patent Document 2 describes that the deformation and wear at the electrode tip are decreased and service life is extended by employing as an alloy composition of a welding electrode material an alloy comprising Cr 0.4-1.0 wt. %, Sn 0.05-0.2 wt. % and copper comprising unavoidable impurities as the balance.

PatentDocument 3 described that electric conductivity is increased and also wear resistance is improved and the number of weld spots (or welding cycles) in spot welding is increased by employing an alloy composition comprising Zr 0.05-1 wt. %, Cr 3-20 wt. %, and Cu as the balance, as a welding electrode material composition.

However, in electrode materials composed of chromium-copper alloys, when the amount of Cr in the form of solid solution is large, electric conductivity and thermal conductivity are low. Another problem is that because the crystal grain size is as large as several tens of microns, cyclic fatigue strength is low. When this material is used as an electrode material, the electrode tip diameter is increased after a small number of welding cycles and the welding current density drops. As a result, the continuous welding ability is low. Another problem is that because of low electric conductivity and thermal conductivity, alloying easily occurs with the material which is welded and the number of weld spots to fusion is low.

On the other hand, in the electrode materials composed of alumina-dispersed copper, yield stress at a high temperature is low, the electrode tip diameter is increased after a small number of welding cycles and welding current density is decreased. As a result, the continuous welding ability is poor. Another problem is that because of low electric conductivity and thermal conductivity, alloying easily occurs with the material which is welded and the number of weld spots to fusion is low.

Further, it was recently suggested to provide an electrode material with high mechanical strength, heat resistance, and electric conductivity by subjecting an alloy material composed of Cu-0.44% Cr-0.2% Zr to lateral extrusion (ECAP: equal-channel angular pressing) and refining the crystal grains (See Non-patent Document 1).

Though the alloy described in the Non-patent Document 1 had excellent mechanical strength and heat resistance, there was still room for improvement because the electric conductivity thereof was as low as 75-80% IACS alloying easily occurred with the material which was welded and the number of weld spots to fusion was low. Another problem is that when crystal grains are refined, yield stress at a high temperature becomes lower than that in a coarse-grain material, for example, due to grain boundary slip, which results in enlarged electrode tip diameter and degraded continuous welding ability.

Documents

Patent Document 1: Japanese Patent Publication No. 56-31196B.

Patent Document 2: Japanese Patent Publication No. 62-3885A.

Patent Document 3: Japanese Patent Publication No. 6-73473A.

Non-patent Document 1: Acta Materialia 50 (2002) 1639-1651 “Structure and properties of ultra-fine grain Cu—Cr—Zr alloy produced by equal-channel angular pressing”.

### SUMMARY OF THE INVENTION

The present invention was made to resolve the above-described problems, and it is an object of the present invention to provide an electrode material in which mechanical properties, heat resistance, yield stress at a high temperature and the continuous welding ability (electrode life) of the electrode material can be improved by forming fibrous crystal grains and a substructure consisting of fine subgrains therein and causing fine precipitation of particles comprising atoms with a low diffusion rate, and also electric conductivity can be increased, alloying of the electrode material with the material which is be welded can be suppressed, and the number of weld spots to fusion (resistance to fusion) can be increased by enhancing the precipitation of fine precipitates, and also to provide a method for the manufacture of such an electrode material.

The present invention was made to solves the above-described problems and the constituent features thereof are described hereinbelow.

(1) An electrode material, having a composition represented by a general formula Cu_{bal.}Xₐ, where X is at least one element selected from the group consisting of Cr, Zr, Fe, P, and Ag; a is 1.5% by weight (wt. %) or less, and the balance is Cu comprising unavoidable impurities, wherein the electrode material has a structure in which fine particles with a mean particle size of 50 nm or less have precipitated in a structure composed of fibrous crystal grains with a minor axis length of 10 μm or less which are composed of subgrains with a mean grain size of 3 μm or less.

(2) The electrode material according to (1) above, wherein the precipitation dispersion state of the fine particles is such that the mean distance between the particles is 200 nm or less.

(3) The electrode material according to (1) or (2) above, wherein the fine particles are of at least one type selected from the group consisting of Cr, Cu₃Zr, Cu₉Zr₂, Fe, Cu₃P, and Ag.

(4) A method for the manufacture of an electrode material, wherein a Cu-based alloy material is extruded at an extrusion ratio of 4 or higher and at a temperature of 300 to 600° C., the Cu-based alloy material having a composition represented by a general formula Cu_{bal.}Xₐ, wherein X is at least one element selected from the group consisting of Cr, Zr, Fe, P, and Ag; a is 1.5% by weight or less, and the balance is Cu comprising unavoidable impurities.

(5) The method for the manufacture of an electrode material, according to (4) above, wherein when the extrusion is conducted, the alloy material is subjected in advance to a heat treatment at a temperature of 350 to 700° C.

(6) The method for the manufacture of an electrode material, according to (4) or (5) above, wherein a heat treatment is conducted at a temperature of 350 to 700° C. after the extrusion.

### BRIEF DESCRIPTION OF THE DRAWINGS

FIG. 1 is an example of the extrusion molding apparatus used in the present invention.

FIGS. 2A and 2B illustrate the metal structure of a material observed by EBSP (electron backscattering pattern) before prior heat treatment and FIG. 2B is an enlarged figure of FIG. 2A.

FIGS. 3A and 3B illustrates the metal structure of the finally treated material observed by EBSP and TEM (transmission electron microscope), respectively.

### DETAILED DESCRIPTION OF THE PREFERRED EMBODIMENTS

In accordance with the present invention, an extrusion method comprising direct extrusion or indirect extrusion at an extrusion ratio of 4 or higher and at a temperature of 300-600° C. is effective specific means for converting the crystal grains of an alloy material into fibrous grains (more specifically, not equiaxial grains with an aspect ratio of 1.5 or more), constituting the substructure by fine subgrains and precipitating the fine grains. This extrusion method changes significantly the cross-sectional area of the alloy material and can provide shear deformation and plastic deformation (strain) to the alloy material by setting adequate conditions of extrusions according these changes of the cross-sectional area. As a result, the minor axis length of fibrous crystal grains can be made not more than 10 μm, the means subgrain diameter of the substructure can be made not more than 3 μm, and the precipitation of fine grains with a means grain diameter of 50 nm or less can be enhanced. Thus, the material can be provided with a high yield strength at a high temperature, a high heat resistance and a high electric conductivity.

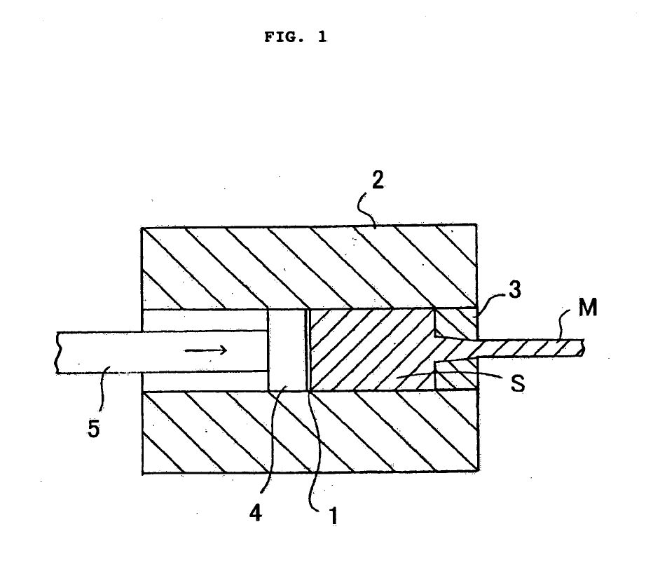

The extrusion molding apparatus used in the extrusion method in accordance with the present invention will be explained based on a direct extrusion molding apparatus shown in FIG. 1. The apparatus comprises a container 2 having formed therein a supply portion 1 passing in the longitudinal direction, a die 3 disposed on one end side of the supply portion 1 and having formed therein an opening with the cross-sectional shape of an extrusion molded material M which is to be molded, and a stem 5 disposed on the other end side of the supply portion 1 and having a dummy block 4 on one side thereof, this stem 5 sliding inside the supply portion 1 toward the die 3.

The extrusion molding apparatus is also provided with heating-cooling means for controlling the temperature inside the container 2, temperature detection means, and temperature control means (not shown in the figures).

In the extrusion molding, the extrusion material S is placed into the supply portion 1, the stem 5 located on the other end side is caused to slide and to push the extrusion material S towards the die 3, thereby producing the extrusion molded material M with the cross-sectional shape matching the opening formed in the die 3. In this case, because the cross-sectional area of the extrusion material S is reduced by the die 3, mechanical strains are provided to the material, crystal grains in the extrusion molded material assume a fibrous shape, subgrains of the substructure are refined, and the precipitation of fine grains is enhanced by strain induction, thereby providing for excellent mechanical properties.

Applying this method to the alloy material makes it possible to obtain a minor axis length of fibrous crystal grains of 10 μm or less, a mean subgrain size of the substructure of 3 μm or less, to refine the mean particle size of precipitates to 50 nm or less, and improve greatly the high-temperature yield stress, heat resistance, toughness, and electric conductivity by a very simple process. Furthermore, this process also has an effect of improving the cast structure as well as eliminating macroscopic and microscopic segregation of the alloying components and thereby homogenizing the alloy.

In accordance with the present invention, it is important that the extrusion by the aforesaid extrusion method be conducted at a temperature of 300 to 600° C. and an extrusion ratio of 4 or more. Such selection can be explained as follows. When the aforementioned temperature is less than 300° C., mechanical strength is improved, but precipitation enhancement of fine precipitates is not conducted sufficiently and electric conductivity cannot be increased. Furthermore when the temperature is higher than 600° C., formation of fibrous crystal grains, refinement of subgrains of the substructure, and refinement of precipitation particles are not implemented, mechanical strength and other properties are not improved, the precipitated dispersed particles are again dissolved in the form of solid solution, and electric conductivity is impossible to increase. Furthermore, when the extrusion ratio is less than 4, formation of fibrous crystal grains of the alloy material, refinement of subgrains of the substructure, and enhancement of fine particle precipitation are not fully advanced and the increase in mechanical strength and electric conductivity cannot be expected.

Furthermore, in accordance with the present invention, when the above-described extrusion method is implemented, it is preferred that a heat treatment at a temperature within a range of from 350 to 700° C. be conducted in advance (this heat treatment will be also referred to hereinbelow as a prior heat treatment). Conducting such a prior heat treatment makes it possible to disperse fine precipitates, to convert crystal grains into a fibrous shape by contributing to pinning of dislocations and the like that were introduced in the extrusion process and to refine the subgrains of the substructure. When the aforesaid temperature is less than 350° C., the precipitation does not occur, and when the aforesaid temperature is above 700° C., the crystal grains and precipitates become too coarse, and even if the extrusion is implemented, the appropriate minor axis length of fibrous crystal grains, the diameter of subgrains of the substructure, and the size of precipitates cannot be controlled. The prior heat treatment can be expected to produce the above-described effect if the treatment time is at least 30 minutes. No specific limitation is placed on the upper limit of the treatment time, but from the standpoint of cost efficiency, it is preferably within 100 hours.

Furthermore, in accordance with the present invention, it is preferred that a heat treatment at a temperature within a range of 350 to 700° C. be conducted after the aforesaid extrusion method has been implemented (this heat treatment will be also referred to hereinbelow as a post heat treatment). Conducting such a post heat treatment makes it possible to precipitate and disperse the precipitates finely and uniformly. Therefore, electric conductivity of the electrode material can be increased. When the aforementioned temperature is less than 350° C., the quantity of the precipitates is insufficient, and the increase in electric conductivity cannot be expected. Further, if the temperature is above 700° C., the precipitated dispersed particles again form a solid solution, easily causing the decrease in electric conductivity. This heat treatment can be expected to produce the above-described effect if the treatment time is at least 10 minutes. No specific limitation is placed on the upper limit of the treatment time, but from the standpoint of cost efficiency, it is preferably within 50 hours.

In accordance with the present invention, conducting the aforementioned prior heat treatment and post heat treatment together is especially preferred because it allows the minor axis length of fibrous crystal grains, mean size of subgrains, and size of fine precipitates to be desirably controlled and also makes it possible to disperse fine precipitates uniformly and to control the precipitation quantity thereof.

The Cu-base alloy material used in accordance with the present invention is preferably from an alloy having a composition represented by a general formula Cu_{bal.}Xₐ (where X is at least one element selected from the group consisting of Cr, Zr, Fe, P, and Ag; a is 1.5% by weight or less, and the balance is Cu comprising unavoidable impurities). X is at least one element selected from the group consisting of Cr, Zr, Fe, P, and Ag, and when those elements are added in an amount of 1.5 wt. % or less, fine precipitates can be precipitated, those precipitates making contribution to the increase of heat treatment and high-temperature yield stress, which is the object of the present invention. No specific restriction is placed on the lower limit, but from the standpoint of ensuring the precipitation of fine precipitates, it is preferred that the aforesaid content be 0.01 wt. % or higher.

Specific examples of especially preferred alloy compositions include Cu—(not more than 1.5%) Cr, Cu—(not more than 0.2%) Zr, Cu—(not more than 1.3%) Cr—(not more than 0.2%) Zr, Cu—(not more than 1.0%) Fe—(not more than 0.2%) P, and Cu—(not more than 0.5%) Ag.

In accordance with the present invention, in the effective structure of the electrode material, the minor axis length of not-equiaxial fibrous crystal grains with an aspect ratio of 1.5 or more is 10 μm or less, the mean size of subgrains of the substructure is 3 μm or less, and the size of fine precipitates (dispersed particle size) is 50 nm or less. Producing such a structure makes it possible to obtain a high-temperature yield stress at a temperature of 500° C., 600° C. of 200 MPa or higher and an electric conductivity (IACS) of 90% or higher. Furthermore, when a structure is obtained in which the minor axis length of fibrous crystal grains is 10 μm or less, the mean size of subgrains of the substructure is 1 μm or less, and the size of fine precipitates (dispersed particle size) is 25 nm or less makes it possible to obtain a high-temperature yield stress at a temperature of 500° C., 600° C. of 250 MPa or higher and an electric conductivity (IACS) of 90% or higher.

Furthermore, the dispersed state of fine precipitates that contribute to the improvement of heat resistance is represented by a mean distance between the particles of 200 nm or less, preferably 100 nm or less. Dispersing the particles with a diameter of no more than 50 nm with the aforesaid spacing makes it possible to suppress the decrease in hardness after holding for several hours at a temperature of 600° C. Further, specific examples of fine precipitates that precipitate in accordance with the present invention include Cr, Cu—Zr system such as Cu₃Zr and Cu₉Zr₂, Fe, Cu₃P, and Ag.

The present invention will be described hereinbelow in greater detail based on examples of the present invention and comparative examples, but it goes without saying that the present invention is not limited to the below-described examples.

### EXAMPLE 1

Electric copper and metals were melted in an argon atmosphere in a high frequency melting furnace and cast into a graphite casting mold to obtain ingots with a diameter of 40 mm and a length of 300 mm. The composition of each of the ingots obtained is shown in Table 1. The ingots were subjected to solution treatment for 2 hours at a temperature of 1000° C. and a heat treatment (prior heat treatment) shown in Table 2 was conducted. After the prior heat treatment, each material was introduced into the extrusion molding apparatus shown in FIG. 1 and directly extruded under conditions shown in Table 3. After the direct extrusion treatment, the materials were subjected to heat treatment (post heat treatment) under the conditions shown in Table 4 and finally treated materials were obtained.

TABLE 1
Compositions of electrode materials

| | Cu | Cr (wt. %) | Zr (wt. %) |
|---|---|---|---|
| A | Balance | 0.84 | 0.03 |
| B | Balance | 1.0 | 0.20 |
| C | Balance | 0.6 | 0.05 |

TABLE 2
Heat treatment conditions

| | Heat treatment temperature × time |
|---|---|
| \mathring{1} | 600° C. × 1 h |
| \mathring{2} | 500° C. × 8 h |
| \mathring{3} | 375° C. × 200 h |

TABLE 3
Extrusion conditions

| | Extrusion temperature (° C.) | Extrusion ratio |
|---|---|---|
| I | 500 | 7 |
| II | 450 | 7 |
| III | 375 | 7 |

TABLE 4
Final heat treatment conditions

| | Heat treatment temperature × time |
|---|---|
| \mathring{1} | 500° C. × 1 h |
| \mathring{2} | 450° C. × 8 h |
| \mathring{3} | 375° C. × 48 h |

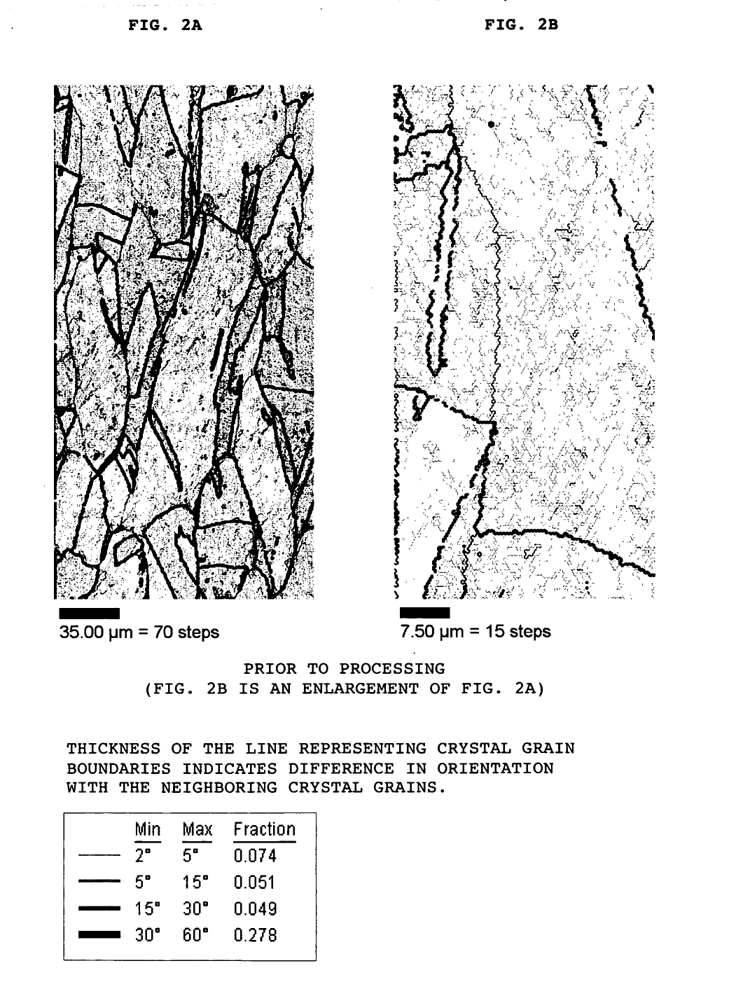

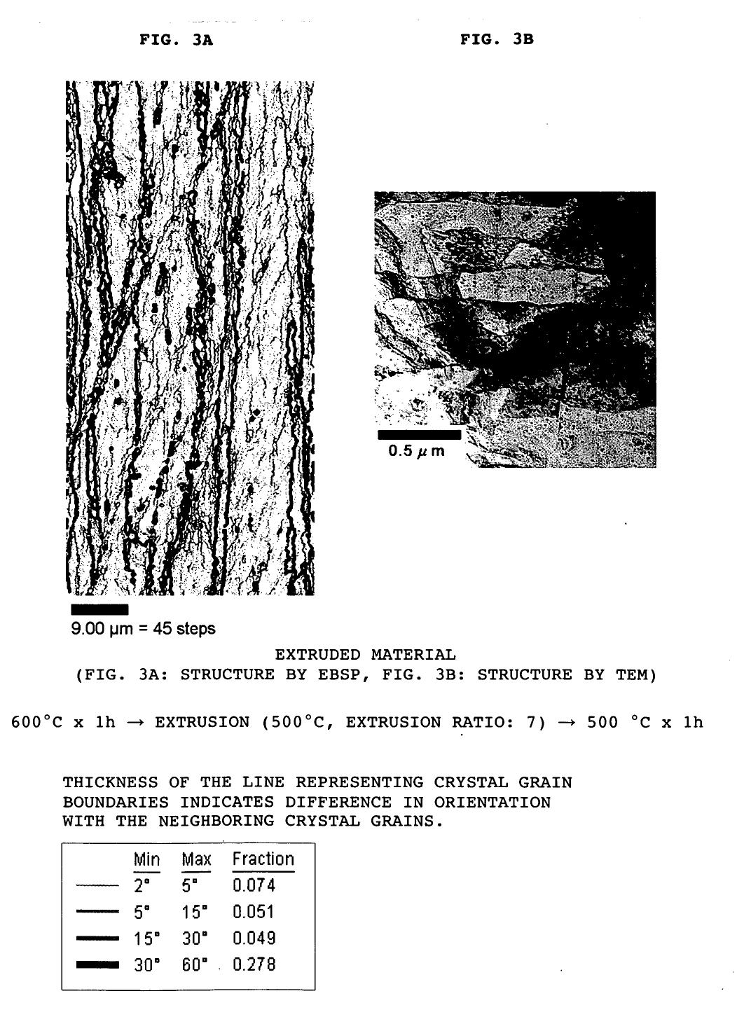

FIG. 2 illustrates the microstructural photographs of the material before the prior heat treatment by EBSP and FIG. 3 shows the microstructural photographs of the finally treated material by EBSP and TEM. The crystal grain size prior to the direct extrusion was 50-100 μm, but the refinement was such that the fibrous crystal grains in the finally treated material had an aspect ratio of 1.5 or higher and were not equiaxial, the minor axis length of the fibrous crystal grains was 10 μm or less, the mean subgrain size of the substructure was 3 μm or less, and the size of fine precipitates (dispersed particle size) was 50 nm or less. Furthermore, the distance between the particles was 200 nm or less and the fine precipitates were uniformly and finely dispersed in the structure.

The results obtained in measuring the yield stress of the finally treated material at a temperature of 600° C. and electric conductivity (% IACS) thereof at room temperature are shown in Tables 5-1 to 5-5. The comparison of the materials in accordance with the present invention and the conventional materials (comparative materials) demonstrates that the yield stress at a temperature of 600° C. increased to 200 MPa or higher and the electric conductivity (% IACS) increased to 90% or higher.

The yield stress at a temperature of 600° C. was measured in a compression test by using a sample with a diameter of 6 mm and a height of 9 mm. Furthermore, the electric conductivity was measured by mirror polishing the surface of the finally treated material, bringing the measurement probe of a digital electric conductivity meter (Autosigma 3000) into contact with the sample surface and obtaining the numerical measurement results.

<Electrode Life Evaluation>

In order to evaluate the electrode life, an electrode with a tip diameter of 6 mm (40 R) was molded, a shot dull finish material obtained from an Al—Mg alloy sheet with a thickness of 1 mm was used as a welding base material after pickling and applying commercial low-viscosity mineral oil. A single-phase AC stationary spot welding apparatus was used and a spot welding test was conducted, while cooling the electrode with water. The welding current was 26 kA, the current passing time was 4 cycles, the pressurizing force was 400 kgf. The welding conditions corresponded to WES7302 and were such as to obtain a nugget with a diameter of 5 mm. The continuous welding speed was 1 spot/2 sec. The electrode life was evaluated by the number of weld spots at which the nugget diameter (a value obtained by adding up a major axis and a minor axis and dividing by 2) was found to be less than 5 mm, upon stripping the welding zone. The electrode life was evaluated by the following evaluation criteria.

(Electrode Life Evaluation Criteria)

◯: number of continuous weld spots is 1000 or more;

×: number of continuous weld spots is less than 1000.

<Evaluation of Resistance to Fusion>

Resistance to fusion was evaluated by the following method. When the electrode material and the material that was welded stuck together in the electrode life evaluation test, a load required to separate the welding material in a tensile test machine was measured and “fusion” was assumed when this load exceeded 10 kgf. Furthermore, the number of weld spots till the fusion state was reached was called the number of weld spots to fusion and the average number of the number of weld spots to fusion was called “the average number of weld spots to fusion” and was considered as an indicator of fusion occurrence frequency. A high average number of weld spots to fusion means a high resistance to fusion. The resistance to fusion was evaluated according to the following evaluation criteria.

(Evaluation Criteria of Resistance to Fusion)

◯: average number of weld spots to fusion is 500 or more;

Δ: average number of weld spots to fusion is 100 to 499;

×: average number of weld spots to fusion less than 100.

<Overall Evaluation>

The results of combined evaluation of continuous welding ability (electrode life) and resistance to welding were overall evaluated according to the following criteria, and the results are shown in the lowermost line of Tables 5-1 to 5-5.

(Overall Evaluation Criteria)

⊚:O in the evaluation of both the continuous welding ability and the resistance to welding;

◯: ◯ or Δ in the evaluation of the continuous welding ability or resistance to welding;

×: evaluation of the continuous welding ability and resistance to welding includes ×.

TABLE 5-1
(Aluminum sheet: No. 1)

| | Invention Material No. | | | | | | | | | |
|---|---|---|---|---|---|---|---|---|---|---|
| | 1 | 2 | 3 | 4 | 5 | 6 | 7 | 8 | 9 | 10 |
| Alloy | A | A | A | A | A | A | A | A | A | A |
| Heat | \mathring{1} | \mathring{1} | \mathring{1} | \mathring{1} | \mathring{1} | \mathring{1} | \mathring{1} | \mathring{1} | \mathring{1} | \mathring{2} |
| treatment | | | | | | | | | | |
| Extrusion | I | I | I | II | II | II | III | III | III | I |
| conditions | | | | | | | | | | |
| Final heat | \mathring{1} | \mathring{2} | \mathring{3} | \mathring{1} | \mathring{2} | \mathring{3} | \mathring{1} | \mathring{2} | \mathring{3} | \mathring{1} |
| treatment | | | | | | | | | | |
| Yield | 213 | 214 | 236 | 225 | 233 | 242 | 213 | 211 | 233 | 226 |
| strength | | | | | | | | | | |
| (MPa) at 600° C. | | | | | | | | | | |
| % IACS | 95 | 95 | 93 | 95 | 94 | 92 | 94 | 94 | 92 | 95 |
| Electrode | 2068 | 2072 | 1950 | 2118 | 2044 | 1867 | 1960 | 1952 | 1830 | 2122 |
| life | | | | | | | | | | |
| Average | 1034 | 1036 | 650 | 1059 | 681 | 467 | 653 | 651 | 457 | 1061 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | ◯ | Δ | ◯ | ◯ | Δ | ◯ |
| (resistance | | | | | | | | | | |
| to fusion) | | | | | | | | | | |
| Overall | ⊚ | ⊚ | ⊚ | ⊚ | ⊚ | ◯ | ⊚ | ⊚ | ◯ | ⊚ |
| evaluation | | | | | | | | | | |

TABLE 5-2
(Aluminum sheet: No. 2)

| | Invention Material No. | | | | | | | | | |
|---|---|---|---|---|---|---|---|---|---|---|
| | 11 | 12 | 13 | 14 | 15 | 16 | 17 | 18 | 19 | 20 |
| Alloy | A | A | A | A | A | A | A | A | A | A |
| Heat | \mathring{2} | \mathring{2} | \mathring{2} | \mathring{2} | \mathring{2} | \mathring{2} | \mathring{2} | \mathring{2} | \mathring{3} | \mathring{3} |
| treatment | | | | | | | | | | |
| Extrusion | I | I | II | II | II | III | III | III | I | I |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 222 | 229 | 217 | 231 | 242 | 229 | 243 | 251 | 221 | 231 |
| strength | | | | | | | | | | |
| (MPa) at 600° C. | | | | | | | | | | |
| % IACS | 94 | 93 | 94 | 93 | 91 | 93 | 92 | 91 | 93 | 91 |
| Electrode | 1998 | 1920 | 1977 | 1929 | 1760 | 1920 | 1872 | 1798 | 1887 | 1714 |
| life | | | | | | | | | | |
| Average | 666 | 640 | 659 | 643 | 440 | 640 | 468 | 449 | 629 | 428 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | Δ | ◯ | Δ | Δ | ◯ | Δ |
| (resistance | | | | | | | | | | |
| to fusion) | | | | | | | | | | |
| Overall | ⊚ | ⊚ | ⊚ | ⊚ | ◯ | ⊚ | ◯ | ◯ | ⊚ | ◯ |
| evaluation | | | | | | | | | | |

TABLE 5-3
(Aluminum sheet: No. 3)

| | Invention Material No. | | | | | | | | | |
|---|---|---|---|---|---|---|---|---|---|---|
| | 21 | 22 | 23 | 24 | 25 | 26 | 27 | 28 | 29 | 30 |
| Alloy | A | A | A | A | B | B | B | B | B | B |
| Heat | \mathring{3} | \mathring{3} | \mathring{3} | \mathring{3} | \mathring{1} | \mathring{1} | \mathring{1} | \mathring{1} | \mathring{1} | \mathring{1} |
| treatment | | | | | | | | | | |
| Extrusion | I | II | II | III | I | I | I | II | II | II |
| conditions | | | | | | | | | | |
| Final heat | \mathring{3} | \mathring{1} | \mathring{2} | \mathring{1} | \mathring{1} | \mathring{2} | \mathring{3} | \mathring{1} | \mathring{2} | \mathring{3} |
| treatment | | | | | | | | | | |
| Yield | 240 | 210 | 236 | 248 | 251 | 243 | 275 | 256 | 271 | 275 |
| strength | | | | | | | | | | |
| (MPa) at 600° C. | | | | | | | | | | |
| % IACS | 90 | 93 | 91 | 92 | 94 | 93 | 92 | 93 | 92 | 91 |
| Electrode | 1644 | 1840 | 1735 | 1893 | 2141 | 1997 | 2008 | 2047 | 1992 | 1894 |
| life | | | | | | | | | | |
| Average | 329 | 613 | 434 | 473 | 714 | 666 | 502 | 682 | 498 | 474 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | Δ | ◯ | Δ | Δ | ◯ | ◯ | ◯ | ◯ | Δ | Δ |
| (resistance | | | | | | | | | | |
| to fusion) | | | | | | | | | | |
| Overall | ◯ | ⊚ | ◯ | ◯ | ⊚ | ⊚ | ⊚ | ⊚ | ◯ | ◯ |
| evaluation | | | | | | | | | | |

TABLE 5-4
(Aluminum sheet: No. 4)

| | Invention Material No. | | | | | | | | | |
|---|---|---|---|---|---|---|---|---|---|---|
| | 31 | 32 | 33 | 34 | 35 | 36 | 37 | 38 | 39 | 40 |
| Alloy | B | B | B | B | B | B | B | B | B | B |
| Heat | \mathring{1} | \mathring{1} | \mathring{1} | \mathring{2} | \mathring{2} | \mathring{2} | \mathring{2} | \mathring{2} | \mathring{2} | \mathring{2} |
| treatment | | | | | | | | | | |
| Extrusion | III | III | III | I | I | I | II | II | II | III |
| conditions | | | | | | | | | | |
| Final heat | \mathring{1} | \mathring{2} | \mathring{3} | \mathring{1} | \mathring{2} | \mathring{3} | \mathring{1} | \mathring{2} | \mathring{3} | \mathring{1} |
| treatment | | | | | | | | | | |
| Yield | 251 | 261 | 259 | 257 | 271 | 251 | 263 | 265 | 263 | |
| strength | | | | | | | | | | |
| (MPa) at 600° C. | | | | | | | | | | |
| % IACS | 93 | 92 | 92 | 93 | 93 | 90 | 94 | 93 | 93 | 94 |
| Electrode | 2016 | 1915 | 1953 | 2059 | 2051 | 1766 | 2141 | 2074 | 2082 | 2188 |
| life | | | | | | | | | | |
| Average | 672 | 479 | 488 | 686 | 684 | 353 | 714 | 691 | 694 | 729 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | Δ | Δ | ◯ | ◯ | Δ | ◯ | ◯ | ◯ | ◯ |
| (resistance | | | | | | | | | | |
| to fusion) | | | | | | | | | | |
| Overall | ⊚ | ◯ | ◯ | ⊚ | ⊚ | ◯ | ⊚ | ⊚ | ⊚ | ⊚ |
| evaluation | | | | | | | | | | |

TABLE 5-5
(Aluminum sheet: No. 5)

| | Invention Material No. | | | | | | | | | |
|---|---|---|---|---|---|---|---|---|---|---|
| | 41 | 42 | 43 | 44 | 45 | 46 | 47 | 48 | 49 | 50 |
| Alloy | B | B | B | B | B | B | B | B | B | B |
| Heat | \mathring{2} | \mathring{2} | \mathring{3} | \mathring{3} | \mathring{3} | \mathring{3} | \mathring{3} | \mathring{3} | \mathring{3} | \mathring{3} |
| treatment | | | | | | | | | | |
| Extrusion | III | III | I | I | I | II | II | II | III | III |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 269 | 275 | 255 | 263 | 273 | 245 | 273 | 272 | 264 | 268 |
| strength | | | | | | | | | | |
| (MPa) at 600° C. | | | | | | | | | | |
| % IACS | 94 | 91 | 93 | 92 | 91 | 93 | 91 | 90 | 92 | 90 |
| Electrode | 2211 | 1894 | 2043 | 1961 | 1887 | 2005 | 1887 | 1769 | 1965 | 1754 |
| life | | | | | | | | | | |
| Average | 737 | 474 | 681 | 490 | 472 | 668 | 472 | 354 | 491 | 351 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | Δ | ◯ | Δ | Δ | ◯ | Δ | Δ | Δ | Δ |
| (resistance | | | | | | | | | | |
| to fusion) | | | | | | | | | | |
| Overall | ⊚ | ◯ | ⊚ | ◯ | ◯ | ⊚ | ◯ | ◯ | ◯ | ◯ |
| evaluation | | | | | | | | | | |

TABLE 5-6
(Aluminum sheet: No. 6)

| | Invention Material No. | | | | | | | | | |
|---|---|---|---|---|---|---|---|---|---|---|
| | 51 | 52 | 53 | 54 | 55 | 56 | 57 | 58 | 59 | 60 |
| Alloy | C | C | C | C | C | C | C | C | C | C |
| Heat | \mathring{1} | \mathring{1} | \mathring{1} | \mathring{1} | \mathring{1} | \mathring{1} | \mathring{1} | \mathring{1} | \mathring{1} | \mathring{2} |
| treatment | | | | | | | | | | |
| Extrusion | I | I | I | II | II | II | III | III | III | I |
| conditions | | | | | | | | | | |
| Final | \mathring{1} | \mathring{2} | \mathring{3} | \mathring{1} | \mathring{2} | \mathring{3} | \mathring{1} | \mathring{2} | \mathring{3} | \mathring{1} |
| heat | | | | | | | | | | |
| treatment | | | | | | | | | | |
| Yield | 231 | 224 | 247 | 236 | 244 | 257 | 230 | 228 | 245 | 246 |
| strength | | | | | | | | | | |
| (MPa) at 600° C. | | | | | | | | | | |
| % IACS | 95 | 93 | 92 | 94 | 93 | 92 | 94 | 92 | 91 | 94 |
| Electrode | 2198 | 1939 | 1911 | 2101 | 2016 | 1950 | 2078 | 1838 | 1787 | 2140 |
| life | | | | | | | | | | |
| Average | 1099 | 646 | 478 | 700 | 672 | 488 | 693 | 459 | 447 | 713 |
| number of | | | | | | | | | | |
| weld | | | | | | | | | | |
| spots to | | | | | | | | | | |
| fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | Δ | ◯ | ◯ | Δ | ◯ | Δ | Δ | ◯ |
| (resistance | | | | | | | | | | |
| to fusion) | | | | | | | | | | |
| Overall | ⊚ | ⊚ | ◯ | ⊚ | ⊚ | ◯ | ⊚ | ◯ | ◯ | ⊚ |
| evaluation | | | | | | | | | | |

TABLE 5-7
(Aluminum sheet: No. 7)

| | Invention Material No. | | | | | | | | | |
|---|---|---|---|---|---|---|---|---|---|---|
| | 61 | 62 | 63 | 64 | 65 | 66 | 67 | 68 | 69 | 70 |
| Alloy | C | C | C | C | C | C | C | C | C | C |
| Heat | \mathring{2} | \mathring{2} | \mathring{2} | \mathring{2} | \mathring{2} | \mathring{2} | \mathring{2} | \mathring{2} | \mathring{3} | \mathring{3} |
| treatment | | | | | | | | | | |
| Extrusion | I | I | II | II | II | III | III | III | I | I |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 240 | 250 | 229 | 243 | 251 | 246 | 252 | 263 | 239 | 244 |
| strength | | | | | | | | | | |
| (MPa) at 600° C. | | | | | | | | | | |
| % IACS | 92 | 92 | 94 | 93 | 91 | 92 | 91 | 90 | 93 | 92 |
| Electrode | 1884 | 1923 | 2074 | 2012 | 1810 | 1907 | 1814 | 1741 | 1997 | 1900 |
| life | | | | | | | | | | |
| Average | 471 | 481 | 691 | 671 | 453 | 477 | 454 | 348 | 666 | 475 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | Δ | Δ | ◯ | ◯ | Δ | Δ | Δ | Δ | ◯ | Δ |
| (resistance | | | | | | | | | | |
| to fusion) | | | | | | | | | | |
| Overall | ◯ | ◯ | ⊚ | ⊚ | ◯ | ◯ | ◯ | ◯ | ⊚ | ◯ |
| evaluation | | | | | | | | | | |

TABLE 5-8
(Aluminum sheet: No. 8)

Invention Material No.

| | 71 | 72 | 73 | 74 |
|---|---|---|---|---|
| Alloy | C | C | C | C |
| Heat treatment | \mathring{3} | \mathring{3} | \mathring{3} | \mathring{3} |
| Extrusion | I | II | II | III |
| conditions | | | | |
| Final heat | \mathring{3} | \mathring{1} | \mathring{2} | \mathring{1} |
| treatment | | | | |
| Yield strength | 266 | 232 | 264 | 259 |
| (MPa) at 600° C. | | | | |
| % IACS | 91 | 93 | 90 | 91 |
| Electrode life | 1869 | 1970 | 1745 | 1842 |
| Average number of | 467 | 657 | 349 | 460 |
| weld spots to | | | | |
| fusion | | | | |
| Evaluation (life) | ◯ | ◯ | ◯ | ◯ |
| Evaluation | Δ | ◯ | Δ | Δ |
| (resistance to | | | | |
| fusion) | | | | |
| Overall evaluation | ◯ | ⊚ | ◯ | ◯ |

TABLE 5-9
(Aluminum sheet: No. 9)

Comparative Material No.

| | 1 | 2 |
|---|---|---|
| | | Alumina- |
| | Cu- | dispersed |
| Material | 1Cr | copper |
| Yield strength | 190 | 140 |
| (MPa) at 600° C. | | |
| % IACS | 84 | 83 |
| Electrode life | 535 | 859 |
| Average number of | 67 | 107 |
| weld spots to | | |
| fusion | | |
| Evaluation (life) | X | X |
| Evaluation | X | Δ |
| (resistance to | | |
| fusion) | | |
| Overall | X | X |
| evaluation | | |

In the materials No. 6, 9, 15, 17, 18, 20, 21, 23, 24, 29, 30, 32, 33, 36, 42, 44, 45, 47-50, 53, 56, 58, 59, 61, 62, 65-68, 70, 71, 73, and 74 in accordance with the present invention, the electric conductivity (% IACS) was low (thermal conductivity was also low; those results are not shown in the table). Therefore, Joule's heat was large, thermal conductivity was low, the electrode materials were easily alloyed with the material which was welded, and the average number of weld spots to fusion was less than 500.

In the comparative material No. 1, the amount of Cr in the form of solid solution was large and electric conductivity (% IACS) was too low (thermal conductivity was also too low; those results are not shown in the table). Therefore, Joule's heat was very large, cooling efficiency was poor, the electrode material temperature increased, and yield stress at a high temperature decreased significantly. Furthermore, because the crystal grain size was as large as several tens of microns, cyclic fatigue strength was low. For the following reasons, the electrode tip diameter increased at a small number of welding cycles and welding current density dropped, resulting in poor continuous welding ability. As for the resistance to fusion, because the electric conductivity (% IACS) was too low (thermal conductivity was also too low; those results are not shown in the table), the electrode material was easily alloyed with the material which was welded, and the average number of weld spots to fusion was small.

In the comparative material No. 2, because the yield stress at a high temperature was low, the continuous welding ability was poor. As for the resistance to fusion, because the electric conductivity (% IACS) was too low (thermal conductivity was also too low; those results are not shown in the table), fusion easily occurred.

The results described above demonstrated that the materials which had a high yield stress at a high temperature, a high heat resistance, a high electric conductivity (% IACS), and also the formation of fibrous crystal grains, refinement of subgrains of the substructure, and fine particle precipitates had excellent welding characteristics.

### EXAMPLE 2

An ingot composed of Cu—0.84% Cr—0.03% Zr was obtained in the same manner as in Example 1. The ingot obtained was solution treated for 2 hours at a temperature of 1000° C. and subjected to prior heat treatment for 2 hours at a temperature of 600° C. After the prior heat treatment, the yield stress at a temperature of 600° C. and electric conductivity were measured. The following results were obtained: yield stress 173 MPa and electric conductivity 83%. Then, the material was inserted in a container shown in FIG. 1 and direct extrusion was conducted at a temperature of 500° C. and an extrusion ratio of 7. After the direct extrusion, the yield stress at a temperature of 600° C. and electric conductivity were measured. As a result of these measurements, there were obtained a yield stress of 225 MPa and an electric conductivity of 92%. Then, heat treatment was conducted for 8 hours at a temperature of 500° C. and a finally treated material was obtained. The yield stress of the finally treated material was 211 MPa, the electric conductivity was 95%, the minor axis length of the fibrous crystal grains was 10 μm or less, the mean subgrain size of the substructure was 1 μm or less, the particle size of fine precipitates was 5-40 nm, and the distance between the particles was 100 nm or less.

### EXAMPLE 3

An electrode material identical to that of Example 1 was used, hot-dip zinc-coated steel sheet (average amount of plated metal was 60 g/m²) with a sheet thickness of 0.8 mm was employed, and a spot welding test was conducted with a single-phase AC stationary spot welding apparatus, while cooling the electrode with water. The welding current was 8.3 kA, the current passing time was 10 cycles (50 Hz), the pressurizing force was 200 kgf. The welding conditions were such as to obtain a nugget with a diameter of 5 mm. The continuous welding speed was 1 weld spot/i sec. The electrode life and resistance to fusion were evaluated by the same methods and according to same criteria as in Example 1. Overall evaluation was also conducted according to the same criteria as in Example 1. The results of overall evaluation are shown in Tables 6-1 to 6-5.

TABLE 6-1
(Zinc-coated steel sheet: No. 1)

| | Invention Material No. | | | | | | | | | |
|---|---|---|---|---|---|---|---|---|---|---|
| | 1 | 2 | 3 | 4 | 5 | 6 | 7 | 8 | 9 | 10 |
| Alloy | A | A | A | A | A | A | A | A | A | A |
| Heat | \mathring{1} | \mathring{1} | \mathring{1} | \mathring{1} | \mathring{1} | \mathring{1} | \mathring{1} | \mathring{1} | \mathring{1} | \mathring{2} |
| treatment | | | | | | | | | | |
| Extrusion | I | I | I | II | II | II | III | III | III | I |
| conditions | | | | | | | | | | |
| Final heat | \mathring{1} | \mathring{2} | \mathring{3} | \mathring{1} | \mathring{2} | \mathring{3} | \mathring{1} | \mathring{2} | \mathring{3} | \mathring{1} |
| treatment | | | | | | | | | | |
| Yield | 213 | 214 | 236 | 225 | 233 | 242 | 213 | 211 | 233 | 226 |
| strength | | | | | | | | | | |
| (MPa) at 600° C. | | | | | | | | | | |
| % IACS | 95 | 95 | 93 | 95 | 94 | 92 | 94 | 94 | 92 | 95 |
| Electrode | 1996 | 2001 | 1737 | 2054 | 1908 | 1581 | 1811 | 1801 | 1537 | 2059 |
| life | | | | | | | | | | |
| Average | 998 | 1000 | 579 | 1027 | 954 | 527 | 905 | 900 | 512 | 1030 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | ◯ | ◯ | ◯ | ◯ | ◯ | ◯ |
| (resistance | | | | | | | | | | |
| to fusion) | | | | | | | | | | |
| Overall | ⊚ | ⊚ | ⊚ | ⊚ | ⊚ | ⊚ | ⊚ | ⊚ | ⊚ | ⊚ |
| evaluation | | | | | | | | | | |

TABLE 6-2
(Zinc-coated steel sheet: No. 2)

| | Invention Material No. | | | | | | | | | |
|---|---|---|---|---|---|---|---|---|---|---|
| | 11 | 12 | 13 | 14 | 15 | 16 | 17 | 18 | 19 | 20 |
| Alloy | A | A | A | A | A | A | A | A | A | A |
| Heat | \mathring{2} | \mathring{2} | \mathring{2} | \mathring{2} | \mathring{2} | \mathring{2} | \mathring{2} | \mathring{2} | \mathring{3} | \mathring{3} |
| treatment | | | | | | | | | | |
| Extrusion | I | I | II | II | II | III | III | III | I | I |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 222 | 229 | 217 | 231 | 242 | 229 | 243 | 251 | 221 | 231 |
| strength | | | | | | | | | | |
| (MPa) at 600° C. | | | | | | | | | | |
| % IACS | 94 | 93 | 94 | 93 | 91 | 93 | 92 | 91 | 93 | 91 |
| Electrode | 1854 | 1703 | 1830 | 1713 | 1395 | 1703 | 1585 | 1439 | 1664 | 1342 |
| life | | | | | | | | | | |
| Average | 927 | 568 | 915 | 571 | 349 | 568 | 528 | 360 | 555 | 335 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | Δ | ◯ | ◯ | Δ | ◯ | Δ |
| (resistance | | | | | | | | | | |
| to fusion) | | | | | | | | | | |
| Overall | ⊚ | ⊚ | ⊚ | ⊚ | ◯ | ⊚ | ⊚ | ◯ | ⊚ | ◯ |
| evaluation | | | | | | | | | | |

TABLE 6-3
(Zinc-coated steel sheet: No. 3)

| | Invention Material No. | | | | | | | | | |
|---|---|---|---|---|---|---|---|---|---|---|
| | 21 | 22 | 23 | 24 | 25 | 26 | 27 | 28 | 29 | 30 |
| Alloy | A | A | A | A | B | B | B | B | B | B |
| Heat | \mathring{3} | \mathring{3} | \mathring{3} | \mathring{1} | \mathring{1} | \mathring{1} | \mathring{1} | \mathring{1} | \mathring{1} | \mathring{1} |
| treatment | | | | | | | | | | |
| Extrusion | I | II | II | III | I | I | I | II | II | II |
| conditions | | | | | | | | | | |
| Final heat | \mathring{3} | \mathring{1} | \mathring{2} | \mathring{1} | \mathring{1} | \mathring{2} | \mathring{3} | \mathring{1} | \mathring{2} | \mathring{3} |
| treatment | | | | | | | | | | |
| Yield | 240 | 210 | 236 | 248 | 251 | 243 | 275 | 256 | 271 | 275 |
| strength | | | | | | | | | | |
| (MPa) at 600° C. | | | | | | | | | | |
| % IACS | 90 | 93 | 91 | 92 | 94 | 93 | 92 | 93 | 92 | 91 |
| Electrode | 1200 | 1611 | 1366 | 1610 | 2057 | 1833 | 1803 | 1896 | 1783 | 1617 |
| life | | | | | | | | | | |
| Average | 300 | 537 | 342 | 537 | 1028 | 611 | 601 | 632 | 594 | 404 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | Δ | ◯ | Δ | ◯ | ◯ | ◯ | ◯ | ◯ | ◯ | Δ |
| (resistance | | | | | | | | | | |
| to fusion) | | | | | | | | | | |
| Overall | ◯ | ⊚ | ◯ | ⊚ | ⊚ | ⊚ | ⊚ | ⊚ | ⊚ | ◯ |
| evaluation | | | | | | | | | | |

TABLE 6-4
(Zinc-coated steel sheet: No. 4)

| | Invention Material No. | | | | | | | | | |
|---|---|---|---|---|---|---|---|---|---|---|
| | 31 | 32 | 33 | 34 | 35 | 36 | 37 | 38 | 39 | 40 |
| Alloy | B | B | B | B | B | B | B | B | B | B |
| Heat | \mathring{1} | \mathring{1} | \mathring{1} | \mathring{2} | \mathring{2} | \mathring{2} | \mathring{2} | \mathring{2} | \mathring{2} | \mathring{2} |
| treatment | | | | | | | | | | |
| Extrusion | III | III | III | I | I | I | II | II | II | III |
| conditions | | | | | | | | | | |
| Final heat | \mathring{1} | \mathring{2} | \mathring{3} | \mathring{1} | \mathring{2} | \mathring{3} | \mathring{1} | \mathring{2} | \mathring{3} | \mathring{1} |
| treatment | | | | | | | | | | |
| Yield | 248 | 251 | 261 | 259 | 257 | 271 | 251 | 263 | 265 | 263 |
| strength | | | | | | | | | | |
| (MPa) at 600° C. | | | | | | | | | | |
| % IACS | 93 | 92 | 92 | 93 | 93 | 90 | 94 | 93 | 93 | 94 |
| Electrode | 1857 | 1686 | 1735 | 1910 | 1901 | 1412 | 2057 | 1930 | 1939 | 2115 |
| life | | | | | | | | | | |
| Average | 619 | 562 | 578 | 637 | 634 | 353 | 1028 | 643 | 646 | 1058 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | ◯ | Δ | ◯ | ◯ | ◯ | ◯ |
| (resistance | | | | | | | | | | |
| to fusion) | | | | | | | | | | |
| Overall | ⊚ | ⊚ | ⊚ | ⊚ | ⊚ | ◯ | ⊚ | ⊚ | ⊚ | ⊚ |
| evaluation | | | | | | | | | | |

TABLE 6-5
(Zinc-coated steel sheet: No. 5)

| | Invention Material No. | | | | | | | | | |
|---|---|---|---|---|---|---|---|---|---|---|
| | 41 | 42 | 43 | 44 | 45 | 46 | 47 | 48 | 49 | 50 |
| Alloy | B | B | B | B | B | B | B | B | B | B |
| Heat | \mathring{2} | \mathring{2} | \mathring{3} | \mathring{3} | \mathring{3} | \mathring{3} | \mathring{3} | \mathring{3} | \mathring{3} | \mathring{3} |
| treatment | | | | | | | | | | |
| Extrusion | III | III | I | I | I | II | II | II | III | III |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 269 | 275 | 255 | 263 | 273 | 245 | 273 | 272 | 264 | 268 |
| strength | | | | | | | | | | |
| (MPa) at 600° C. | | | | | | | | | | |
| % IACS | 94 | 91 | 93 | 92 | 91 | 93 | 91 | 90 | 92 | 90 |
| Electrode | 2144 | 1617 | 1891 | 1744 | 1607 | 1842 | 1607 | 1417 | 1749 | 1398 |
| life | | | | | | | | | | |
| Average | 1072 | 404 | 630 | 581 | 402 | 614 | 402 | 354 | 583 | 349 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | Δ | ◯ | ◯ | Δ | ◯ | Δ | Δ | ◯ | Δ |
| (resistance | | | | | | | | | | |
| to fusion) | | | | | | | | | | |
| Overall | ⊚ | ◯ | ⊚ | ⊚ | ◯ | ⊚ | ◯ | ◯ | ⊚ | ◯ |
| evaluation | | | | | | | | | | |

TABLE 6-6
(Zinc-coated steel sheet: No. 6)

| | Invention Material No. | | | | | | | | | |
|---|---|---|---|---|---|---|---|---|---|---|
| | 51 | 52 | 53 | 54 | 55 | 56 | 57 | 58 | 59 | 60 |
| Alloy | C | C | C | C | C | C | C | C | C | C |
| Heat | \mathring{1} | \mathring{1} | \mathring{1} | \mathring{1} | \mathring{1} | \mathring{1} | \mathring{1} | \mathring{1} | \mathring{1} | \mathring{2} |
| treatment | | | | | | | | | | |
| Extrusion | I | I | I | II | II | II | III | III | III | I |
| conditions | | | | | | | | | | |
| Final heat | \mathring{1} | \mathring{2} | \mathring{3} | \mathring{1} | \mathring{2} | \mathring{3} | \mathring{1} | \mathring{2} | \mathring{3} | \mathring{1} |
| treatment | | | | | | | | | | |
| Yield | 231 | 224 | 247 | 236 | 244 | 257 | 230 | 228 | 245 | 246 |
| strength | | | | | | | | | | |
| (MPa) at 600° C. | | | | | | | | | | |
| % IACS | 95 | 93 | 92 | 94 | 93 | 92 | 94 | 92 | 91 | 94 |
| Electrode | 2105 | 1701 | 1627 | 1944 | 1798 | 1675 | 1915 | 1535 | 1432 | 1993 |
| life | | | | | | | | | | |
| Average | 1053 | 567 | 542 | 972 | 599 | 558 | 958 | 512 | 358 | 996 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | ◯ | ◯ | ◯ | ◯ | Δ | ◯ |
| (resistance | | | | | | | | | | |
| to fusion) | | | | | | | | | | |
| Overall | ⊚ | ⊚ | ⊚ | ⊚ | ⊚ | ⊚ | ⊚ | ⊚ | ◯ | ⊚ |
| evaluation | | | | | | | | | | |

TABLE 6-7
(Zinc-coated steel sheet: No. 7)

| | Invention Material No. | | | | | | | | | |
|---|---|---|---|---|---|---|---|---|---|---|
| | 61 | 62 | 63 | 64 | 65 | 66 | 67 | 68 | 69 | 70 |
| Alloy | C | C | C | C | C | C | C | C | C | C |
| Heat | \mathring{2} | \mathring{2} | \mathring{2} | \mathring{2} | \mathring{2} | \mathring{2} | \mathring{2} | \mathring{2} | \mathring{3} | \mathring{3} |
| treatment | | | | | | | | | | |
| Extrusion | I | I | II | II | II | III | III | III | I | I |
| conditions | | | | | | | | | | |
| Final heat | \mathring{2} | \mathring{3} | \mathring{1} | \mathring{2} | \mathring{3} | \mathring{1} | \mathring{2} | \mathring{3} | \mathring{1} | \mathring{2} |
| treatment | | | | | | | | | | |
| Yield | 240 | 250 | 229 | 243 | 251 | 246 | 252 | 263 | 239 | 244 |
| strength | | | | | | | | | | |
| (MPa) at 600° C. | | | | | | | | | | |
| % IACS | 92 | 92 | 94 | 93 | 91 | 92 | 91 | 90 | 93 | 92 |
| Electrode | 1593 | 1641 | 1910 | 1793 | 1461 | 1622 | 1466 | 1334 | 1773 | 1612 |
| life | | | | | | | | | | |
| Average | 531 | 547 | 955 | 598 | 365 | 541 | 366 | 333 | 591 | 537 |
| number of | | | | | | | | | | |
| weld spots | | | | | | | | | | |
| to fusion | | | | | | | | | | |
| Evaluation | ◯ | ◯ | ◯ | ◯ | ◯ | ◯ | ◯ | ◯ | ◯ | ◯ |
| (life) | | | | | | | | | | |
| Evaluation | ◯ | ◯ | ◯ | ◯ | Δ | ◯ | Δ | Δ | ◯ | ◯ |
| (resistance | | | | | | | | | | |
| to fusion) | | | | | | | | | | |
| Overall | ⊚ | ⊚ | ⊚ | ⊚ | ◯ | ⊚ | ◯ | ◯ | ⊚ | ⊚ |
| evaluation | | | | | | | | | | |

TABLE 6-8
(Zinc-coated steel sheet: No. 8)

Invention Material No.

| | 71 | 72 | 73 | 74 |
|---|---|---|---|---|
| Alloy | C | C | C | C |
| Heat treatment | \mathring{3} | \mathring{3} | \mathring{3} | \mathring{3} |
| Extrusion conditions | I | II | II | III |
| Final heat treatment | \mathring{3} | \mathring{1} | \mathring{2} | \mathring{1} |
| Yield strength (MPa) | 266 | 232 | 264 | 259 |
| at 600° C. | | | | |
| % IACS | 91 | 93 | 90 | 91 |
| Electrode life | 1534 | 1739 | 1338 | 1500 |
| Average number of | 383 | 580 | 335 | 375 |
| weld spots to fusion | | | | |
| Evaluation (life) | ◯ | ◯ | ◯ | ◯ |
| Evaluation | Δ | ◯ | Δ | Δ |
| (resistance to | | | | |
| fusion) | | | | |
| Overall evaluation | ◯ | ⊚ | ◯ | ◯ |

TABLE 6-9
(Zinc-coated steel sheet: No. 9)

Comparative
Material No.

| | 1 | 2 |
|---|---|---|
| Material | Cu— | Alumina- |
| | 1Cr | dispersed |
| | | copper |
| Yield strength (MPa) at | 190 | 140 |
| 600° C. | | |
| % IACS | 84 | 83 |
| Electrode life | 928 | 414 |
| Average number of weld | 309 | 414 |
| spots to fusion | | |
| Evaluation (life) | X | X |
| Evaluation (resistance | Δ | Δ |
| to fusion) | | |
| Overall evaluation | X | X |

In the materials No. 15, 18, 20, 21, 23, 30, 36, 42, 45, 47, 48, 50, 59, 65, 67, 68, 71, 73, and 74 in accordance with the present invention, the electric conductivity (% IACS) was low (thermal conductivity was also low; those results are not shown in the table). Therefore, Joule's heat was large, thermal conductivity was low, the electrode materials were easily alloyed with the material which is welded, and the average number of weld spots to fusion was less than 500. In the comparative materials No. 1 and 2, the continuous welding ability and resistance to fusion were poor for the same reasons as in Example 1.

The results described above demonstrated that the materials which had a high yield stress at a high temperature, a high heat resistance, a high electric conductivity (% IACS) and which comprised fibrous crystal grains having a substructure composed of refined subgrains and contained fine particle precipitates therein had excellent welding characteristics.

With the electrode material in accordance with the present invention and a method for the manufacture thereof, an electrode material can be provided in which mechanical properties, heat resistance, yield stress at a high temperature, and continuous welding ability (electrode life) of the electrode material can be improved by forming fibrous crystal grains and the substructure consisting of fine subgrains and causing fine precipitation of particles comprising atoms with a low diffusion rate. Further, by enhancing the precipitation of fine precipitates, electric conductivity can be increased, alloying of the electrode material with the material to be welded can be suppressed and the number of weld spots to fusion (fusion resistance) can be increased. Furthermore, an electrode material with excellent characteristics can be manufactured.

What is claimed is:

1. An electrode material, having a composition represented by a general formula Cu_{bal.}Xₐ, wherein X is at least one element selected from the group consisting of Cr, Zr, Fe, P, and Ag; a is 1.5% by weight or less, and the balance is Cu comprising unavoidable impurities, wherein the electrode material has a structure in which fine particles with a mean particle size of 50 nm or less have precipitated in a structure composed of fibrous crystal grains with a minor axis length of 10 μm or less which are composed of subgrains with a mean grain size of 3 μm or less.

2. The electrode material according to claim 1, wherein the precipitation dispersion state of said fine particles is such that the mean distance between the particles is 200 nm or less.

3. The electrode material according to claim 1, wherein said fine particles are of at least one type selected from the group consisting of Cr, Cu₃Zr, Cu₉Zr₂, Fe, Cu₃P, and Ag.

4. A method for the manufacture of an electrode material, wherein a Cu-based alloy material is extruded at an extrusion ratio of 4 or higher and at a temperature of 300 to 600° C., said Cu-based alloy material having a composition represented by a general formula Cu_{bal.}Xₐ, wherein X is at least one element selected from the group consisting of Cr, Zr, Fe, P, and Ag; a is 1.5% by weight or less, and the balance is Cu comprising unavoidable impurities.

5. The method for the manufacture of an electrode material, according to claim 4, wherein when said extrusion is conducted, the alloy material is subjected in advance to a heat treatment at a temperature of 350 to 700° C.

6. The method for the manufacture of an electrode material, according to claim 4, wherein a heat treatment is conducted at a temperature of 350 to 700° C. after said extrusion.
